(19) United States
(12) Patent Application Publication
(10) Pub. No.: US 2026/0076866 A1
(43) Pub. Date: Mar. 19, 2026

(54) SEXUAL STIMULATION DEVICE

(71) Applicant: Dongguan Mimao Electronic Technology Co., Ltd., Dongguan (CN)

(72) Inventors: Qinling WANG, Heyuan (CN); Qinduo WANG, Heyuan (CN); Yanna CHEN, Dongguan (CN)

(21) Appl. No.: 19/325,571

(22) Filed: Sep. 11, 2025

(30) Foreign Application Priority Data
Sep. 13, 2024 (CN) 202422259851.X
Oct. 11, 2024 (CN) 202422463128.3
Dec. 26, 2024 (CN) 202411942409.5
May 29, 2025 (CN) 202521093317.4

(51) Int. Cl. A61H 19/00; A61H 23/02

(52) U.S. Cl. CPC A61H 19/32; A61H 23/02; A61H 2201/0153; A61H 2201/0207; A61H 2201/10; A61H 2201/1207; A61H 2201/149; A61H 2201/169; A61H 2201/5056; A61H 2201/5061; A61H 2201/5082

(57) ABSTRACT

A sexual stimulation device includes a first massage component, including a first massage element and defining an elongated massage space for accommodating a penis, the massage space having a first axial end for insertion of the penis and a second axial end opposite to the first axial end, at least the first axial end being open; a second massage component, connected to the first massage component and including a second massage element formed in a tongue-like shape, the second massage element being arranged at or adjacent to a periphery of the first axial end of the massage space, wherein the first massage element is configured to provide a first stimulation to the male penis, and the second massage element is configured to provide a second stimulation to a region adjacent to the male penis.

### CROSS-REFERENCE TO RELATED APPLICATIONS

This application claims priorities of Chinese Invention Application No. 202411942409.5, filed on Dec. 26, 2024, Chinese Utility Model Application No. 202422463128.3, filed on Oct. 11, 2024, Chinese Utility Model Application No. 202422259851.X, filed on Sep. 13, 2024, and Chinese Utility Model Application No. 202521093317.4, filed on May. 29, 2025. The contents of which are incorporated herein by reference.

### TECHNICAL FIELD

The present disclosure relates to the technical field of adult products, and in particular to a sexual stimulation device.

### BACKGROUND

In recent years, sexual stimulation devices have been developed to help users to release their sex pressure. Typical sexual stimulation devices, such as masturbators, just use vibration motors to provide high-frequency vibrations to the users' sensitive areas, such as the male genitalia, the female genitalia, and the like. The traditional sexual stimulation devices have monotonous stimulation effects and are therefore unable to satisfy users' needs.

### SUMMARY

An object of the present disclosure is to provide a sexual stimulation device with a better stimulation effect to improve the users' sexual experience.

In order to achieve the above object, according to a first aspect, the present disclosure provides a sexual stimulation device, the sexual stimulation device including:
a first massage component, including a first massage element and defining an elongated massage space for accommodating a penis, the massage space having a first axial end for insertion of the penis and a second axial end opposite to the first axial end, at least the first axial end is open;
a second massage component, connected to the first massage component and including a second massage element formed in a tongue-like shape, wherein the second massage element is arranged at or adjacent to a periphery of the first axial end of the massage space;
wherein the first massage element is configured to provide a first stimulation to the male penis, and the second massage element is configured to provide a second stimulation to a region adjacent to the male penis.

Embodiments of the present disclosure further provide another sexual stimulation device, including:
a first massage component, defining an elongated massage space for accommodating a penis, the massage space having a first axial end for insertion of the penis and a second axial end opposite to the first axial end, at least the first axial end is open;
a second massage component, connected to the first massage component and arranged at or adjacent to a periphery of the first axial end of the massage space;
a driving assembly, including a motor and a gearbox, wherein the motor is configured to output torque to the second massage component via the gearbox and drive the second massage component to move.

Embodiments of the present disclosure furthermore provide yet another sexual stimulation device, including:
a first massage component, defining an elongated massage space for accommodating a penis, the massage space having a first axial end for insertion of the penis and a second axial end opposite to the first axial end, at least the first axial end being open;
a second massage component, connected to the first massage component and including a second massage element, the second massage element being arranged at or adjacent to a periphery of the first axial end of the massage space;
wherein the second massage element has a recess on a surface facing a longitudinal extension of an outer periphery of the elongated massage space.

Compared with the prior art, the sexual stimulation device provided by the embodiments of the present disclosure has a plurality of massage components, wherein the second massage component is connected to the first massage component, and arranged at or adjacent to a periphery of the first axial end of the massage space, which can provide internal and external dual stimulations simultaneously on different parts of the users. The users can experience multiple massage effects while using the sexual stimulation device, with enhanced stimulation, improving the massage experience.

### BRIEF DESCRIPTION OF THE DRAWINGS

In order to illustrate the technical solution in embodiments of the present disclosure more clearly, the following briefly introduces accompanying drawings used in the description of the embodiments. Apparently, the accompanying drawings in the following description are only some embodiments of the present disclosure. Those of ordinary skill in the art can obtain other accompanying drawings from these accompanying drawings without any creative efforts.

FIG. 1 is a schematic structural view of a sexual stimulation device according to an embodiment of the present disclosure.

FIG. 2 is a schematic structural view of the sexual stimulation device illustrated in FIG. 1 at one of the viewpoints.

FIG. 3 is a sectional schematic view of the sexual stimulation device illustrated in FIG. 2, taken along a line A-A.

FIG. 4 is an exploded view of the sexual stimulation device in FIG. 1.

FIG. 5 is a further exploded view of the sexual stimulation device illustrated in FIG. 4, wherein the main structures, such as a driving assembly, are shown schematically.

FIG. 6 is a further exploded view of the sexual stimulation device illustrated in FIG. 5, wherein the main structures, such as a driving assembly, are shown schematically.

FIG. 7 is an exploded view of the sexual stimulation device illustrated in FIG. 1, wherein main structures, such as a first shell, a second massage element and a driving assembly are shown schematically.

FIG. 8 is a schematic structural view of a sexual stimulation device according to another embodiment of the present disclosure.

FIG. 9 is a schematic plan view of the sexual stimulation device illustrated in FIG. 8.

FIG. 10 is a schematic sectional view of the sexual stimulation device illustrated in FIG. 9, taken along a line B-B.

FIG. 11 is a schematic sectional view of the sexual stimulation device illustrated in FIG. 9, taken along a line C-C.

FIG. 12 is an exploded view of the sexual stimulation device illustrated in FIG. 8.

FIG. 13 is a further exploded view illustrated in FIG. 12, wherein the main structures of a driving assembly for a first massage element are shown schematically.

FIG. 14 is a schematic structural view of the sexual stimulation device illustrated in FIG. 13, from another aspect.

FIG. 15 is a further exploded view illustrated in FIG. 12, wherein the main structures of a driving assembly for a second massage element are shown schematically.

FIG. 16 is a schematic structural view of a sexual stimulation device according to yet another embodiment of the present disclosure.

FIG. 17 is a schematic structural view of the sexual stimulation device illustrated in FIG. 16 at one of the viewpoints.

FIG. 18 is a schematic sectional view of the sexual stimulation device illustrated in FIG. 17, taken along a line D-D.

FIG. 19 is an exploded view of the sexual stimulation device illustrated in FIG. 16.

FIG. 20 is a further exploded view illustrated in FIG. 19, wherein the main structures of a driving assembly for a first massage element are shown schematically.

FIG. 21 is a schematic structural view of the sexual stimulation device illustrated in FIG. 20, from another aspect.

FIG. 22 is a further exploded view illustrated in FIG. 19, wherein the main structures of a driving assembly for a second massage element are shown schematically.

### LIST OF REFERENCE SIGNS

Sexual stimulation device 100; casing 10; mounting opening 11; first shell 12; first inner cavity 121; first lumen 122; second shell 13; second inner cavity 131; second lumen 132; partition 14; perforation 141; suction port 142; intake port 143; hanging lug 15; passage 16; mounting space 17; first axial end 18; second axial end 19; first massage component 2; first massage element 20; massage space 21; first sub-space 211; second sub-space 212; central longitudinal axis L1; opening 22; flange 23; granular bumps 24; second massage component 3; second massage element 30; recess 301; swing axis L2; stimulating component 31; driving assembly 40; motor 41; first transmission unit 42; first gear transmission set 421; first transmission shaft 422; first end of the first transmission shaft, 422a; second end of the first transmission shaft, 422b; first shaft rod 423; second shaft rod 424; first groove 425; first support member 426; connecting block 427; pin slider 428; socket portion 429; recess 429a; first hooks 430; second hooks 431; first gear portion 432; first polygon shaft 433; first sleeve portion 434; inner housing 435; connecting shaft 436; second transmission unit 44; second gear transmission set 441; second transmission shaft 442; first end of the second transmission shaft, 442a; second end of the second transmission shaft, 442b; second support member 443; slot 444; third shaft rod 445; first section 446; second section 447; second gear portion 448; second sleeve portion 449; second polygon shaft 450; pin shaft 451; swing end 452; wheel 453; battery 51; first conductive component 52; conductive plug 521; second conductive component 53; conductive socket 531; circuit board 54; vibration motor 60; lip 61; insertion channel 611; first motor 70; first transmission unit 71; first gear transmission set 711; guide rail 712; support 713; groove 714; protrusion 715; first bevel gear 716; second bevel gear 717; sliding block 718; second motor 72; second transmission unit 73; output gear 731; ferrule 732; gear portion 733; third motor 74; third transmission unit 75; negative pressure generator 76; valve 77; gearbox 78; transmission unit 80; gear transmission set 81; worm 811; worm gear 812; first gear portion 813; second gear portion 814; first driving gear 815; second driving gear 816; curved shaft 82; transition segment 821; swaying segment 822; support member 83; handle 90; rotation axis L3.

### DESCRIPTION OF THE EMBODIMENTS

In order to make those skilled in the art better understand the technical solution of the present disclosure, the technical solution in the embodiments of the present disclosure will be clearly and completely described below with reference to accompanying drawings in the embodiments of the present disclosure. Apparently, the described embodiments are merely a part of the embodiments of the present disclosure, but not all of the embodiments. Based on the embodiments of the present disclosure, all other embodiments obtained by those skilled in the art without any creative efforts fall within the protection scope of the present disclosure.

It should be noted that when an element is said to be “connected” to another element, it may be directly connected to another element, or indirectly connected to another element through one or multiple intermediate elements.

In the specification, the oriental or positional relationships indicated by the terms “lateral”, “longitudinal”, “transverse”, “top”, “bottom”, “inner”, “outer”, “central”, “axial”, “radial”, “circumferential”, “vertical” and the like are only intended to facilitate the description of the present disclosure and simplify the description based on oriental or positional relationships shown in the accompanying drawings, not to indicate or imply that the apparatus or element referred must have a specific orientation, is constructed and operated in a specific orientation, and therefore cannot be understood as a limitation of the present disclosure.

Unless otherwise specified and limited, the specific meanings of all technical and scientific terms used in the specification can be specifically understood by persons of ordinary skill in the art. The terms used in the specification of this application are for the purpose of describing specific embodiments only and are not intended to limit this application.

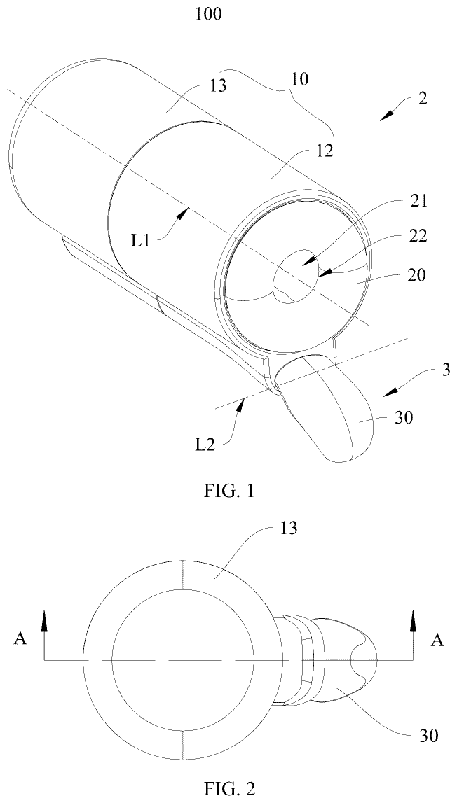

Referring to FIGS. 1 to 4, a sexual stimulation device 100 according to an embodiment of the present disclosure is shown. The sexual stimulation device 100 includes a first massage component 2 having an elongated massage space 21 for accommodating a penis and a second massage component 3 connected to the first massage component 2. The massage space 21 has a first axial end 18 for insertion of the penis and a second axial end 19 opposite to the first axial end 18. At least the first axial end 18 is open. The second massage component 3 is arranged at or adjacent to a periphery of the first axial end 18 of the massage space 21.

Specifically, the first massage component 2 includes a first massage element 20 and a casing 10 having a mounting space 17. The first massage element 20 is connected to the casing 10 and mounted in the mounting space 17.

The second massage component 3 includes a second massage element 30 formed in a tongue-like shape, which can provide visual stimulation effects for users. In this embodiment, a first axial end of the casing 10 is provided with a mounting opening 11, through which the first massage element 20 is mounted in the casing 10. The first massage element 20 is hollow and defines the massage space 21 therein, and an opening 22 is defined at the first axial end 18 of the massage space 21. The opening 22 communicates the massage space 21 with an outside of the casing 10, i.e., serves as an entrance of the massage space 21. The penis of the user can be inserted into the massage space 21 through the opening 22. In this embodiment, the first massage element 20 is detachably connected to the casing 10. Alternatively, the first massage element 20 may be permanently mounted in the mounting space 17 of the casing 10.

The second massage element 30 is arranged outside of the casing 10 and located on or adjacent to a periphery of the first axial end 18, for massaging the region adjacent to the penis, such as testicles, perineum, and anus. Preferably, the end of the second massage element 30 abuts against the casing 10 or is detachably connected to the casing 10. The means of the detachable connection include, but are not limited to, interference fit and adhesive bonding and the like.

An upper surface of the second massage element 30 that faces a central longitudinal axis L1 of the massage space 21 is curved. Specifically, the upper surface in this embodiment is a convex surface. Compared to a flat surface, the convex surface may provide enhanced stimulation to the sensitive region of user. Alternatively, the upper surface may be concaved and has a recess 301 (shown in FIG. 8). The recess 301 on the surface can better hold or embrace the region adjacent to the penis, which may prevent the region adjacent to the penis from detaching from the second massage element 30 during the massage process.

It should be understood that, the recess 301 may be shaped in various ways, which is not particularly limited. In some embodiments, the second massage element 30 may be shaped as a bowl-like structure or a pocket-like structure with an approximately hemispherical concave surface.

The first massage element 20 is configured to provide a first stimulation to the male penis, and the second massage element 30 is configured to provide a second stimulation to the region adjacent to the male penis.

The sexual stimulation device 100 provided by one embodiment of the present disclosure has a plurality of massage components 2, 3, wherein the second massage component 3 is connected to the first massage component 2, and arranged at or adjacent to a periphery of the first axial end 18 of the massage space 21, which can provide internal and external stimulations simultaneously on different parts of the users. The users can experience multiple massage effects while using the sexual stimulation device 100, with enhanced stimulation, improving the massage experience.

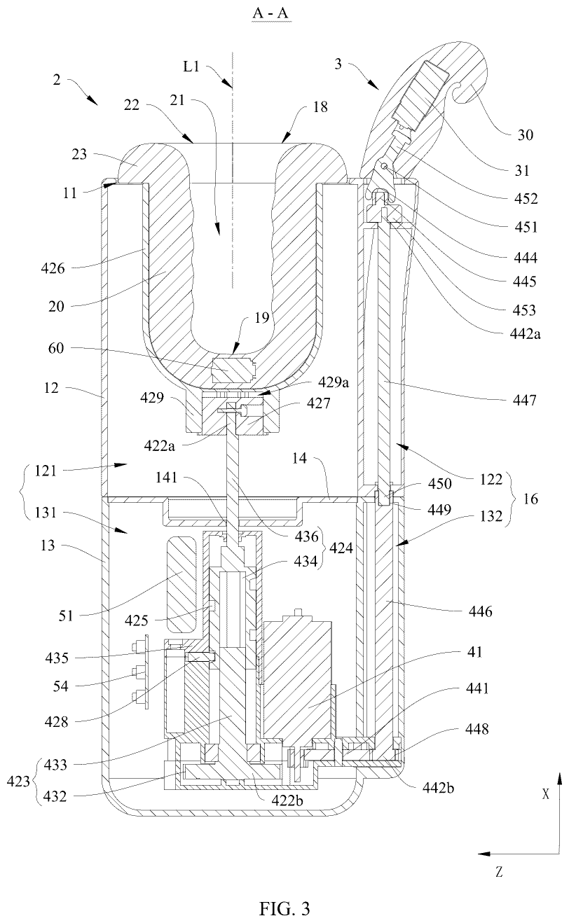

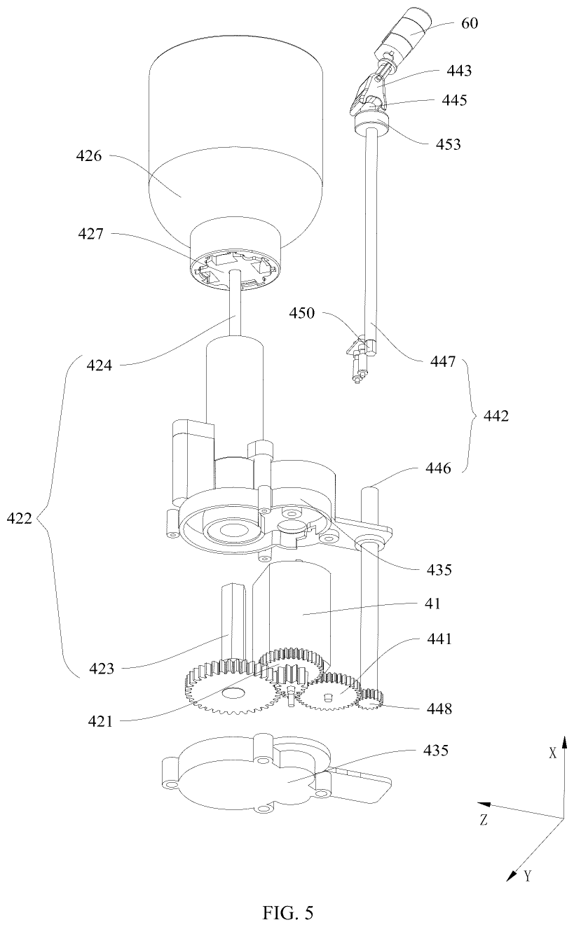

Exemplarily, referring to FIGS. 1 to 3, the first massage element 20 is substantially cylindrical, and its axial direction extends along a longitudinal direction of the casing 20, i.e., along the X-direction in FIGS. 3 to 6. The interior of the first massage element 20 defines the massage space 21 which is substantially cylindrical. The shape of the opening 22 is not particularly limited, and can be designed to allow accommodating various penises with different sizes. Exemplarily, the shape of the opening 22 includes, but is not limited to, a circle or any other arbitrary shape.

In one embodiment of the present disclosure, the shape of the mounting opening 11 is adapted to the outer shape of the first massage element 20, so that the first massage element 20 can be assembled to or removed from the casing 10 conveniently through the mounting opening 11.

Preferably, at least a portion of the first massage element 20 is positioned on the exterior of the casing 10 for easy grasping by the users. For example, the axial end of the first massage element 20 having the opening 22 extends radially outwardly to form a flange 23, an outer diameter of the flange 23 is greater than an inner diameter of the mounting opening 11. After assembly, the flange 23 is located outside the casing 10 and covers the periphery of the mounting opening 11 of the casing 10, and thus users can conveniently remove the first massage element 20 from the casing 10 by grasping the flange 23.

The first massage element 20 is detachably mounted in the casing 10 through the mounting opening 11, and can be detached from the casing 10 for cleaning, thereby facilitating the maintenance and replacement of the first massage element 20 and enhancing its safety and hygiene of the sexual stimulation device 100 while in use.

In one embodiment of the present disclosure, the casing 10 is rigid and made of a hard material, including but not limited to hard plastics such as polypropylene (PP), polyvinyl chloride (PVC), polycarbonate (PC), etc. Thus, it provides sufficient strength of structural support for the components received therein. In one embodiment of the present disclosure, the first massage element 20 is made of a soft material that is skin-friendly, having a Shore A hardness not exceeding 30, including but not limited to a stretchable and soft silicone, TPE (Thermoplastic Elastomer), TPU (Thermoplastic Polyurethane) or PVC (Polyvinyl Chloride), which is non-toxic, antibacterial, and has good chemical stability. The first massage element 20 which is made of a skin-friendly soft material can improve the users' experience.

As such, the flange 23 of the first massage element 20 that covers the periphery of the mounting opening 11 can provide soft and comfortable contact to the user's penis, further improving the user experience.

In one embodiment of the present disclosure, the second massage element 30 is made of a soft material that is skin-friendly, having a Shore A hardness not exceeding 30, including but not limited to a stretchable and soft silicone, TPE (Thermoplastic Elastomer), TPU (Thermoplastic Polyurethane) or PVC (Polyvinyl Chloride), which is non-toxic, antibacterial, and has good chemical stability. Similarly, the second massage element 30 which is made of a skin-friendly soft material can improve the users' experience.

In one embodiment of the present disclosure, referring to FIGS. 1 to 4, the casing 10 is a hollow structure. Exemplarily, the shape of the casing 10 includes, but is not limited to, a column, a sphere, an ellipsoid, etc. In one embodiment, the casing 10 is substantially a hollow cylindrical structure, the mounting space 17 is defined within the interior of the hollow cylindrical structure. In other embodiments, the casing 10 may be substantially cylindrical that is unclosed in the circumferential direction with a gap, for example, it may have a C-shaped or U-shaped section perpendicular to its axial direction, where the inner surfaces of the C-shaped or U-shaped cylindrical structure collectively form the mounting space 17.

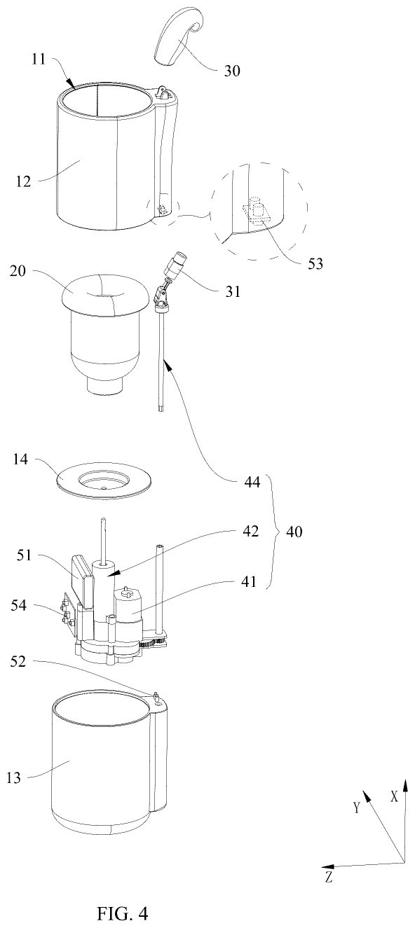

In one embodiment of the present disclosure, referring to FIG. 4, the casing 10 includes a first shell 12 and a second shell 13 detachably connected one another along an axial direction of the casing 10. Both the first and second massage elements 20, 30 are connected to the first shell 12, wherein the second massage element 30 is located at an axial end of the first shell 12 away from the second shell 13.

The sexual stimulation device 100 further includes a driving assembly 40, the driving assembly 40 is configured to drive the first massage element 20 and/or the second massage element 30 to move relative to the casing 10. In this embodiment, the driving assembly 40 is mainly mounted in the second shell 13.

Specifically, the driving assembly 40 may drive the first massage element 20 and the second massage element 30 to move relative to the casing 10 simultaneously or separately. The motion provided by the first massage element 20 may be linear motion, rotational motion, or both. The motion provided by the second massage element 30 may be swinging motion, rotational motion, or both. The movements of the first and second massage elements 20, 30 can be provided simultaneously, and thus the users can experience multiple massage effects while using the sexual stimulation device 100, the stimulation is enhanced and the massage experience is improved.

Meanwhile, since the first and second shell 12, 13 are detachable and thus it is possible to remove the first shell 12 from the second shell 13, as such, it is easy for the users to clean the first and second massage elements 20, 30 mounted at the first shell 12, and it is also convenient for replacing and maintaining the partial components of the driving assembly 40 received in the second shell 13, thereby reducing the difficulty of maintenance and increasing the product life. The detachable connection between the first shell 12 and the second shell 13 may be, but not limited to, snap-fit connection, threaded connection, magnetic connection, etc.

In one embodiment of the present disclosure, referring to FIGS. 3 and 4, the sexual stimulation device 100 further includes a circuit board 54 received in the second shell 13. The second shell 13 is provided with a first conductive component 52 electrically connected to the circuit board 54, the second massage component 3 is provided with a stimulating component 31. The first shell 12 is provided with a second conductive component 53 electrically connected to the stimulating component 31. The first and second conductive components are connected each other when the first and second shells 12, 13 are assembled, thereby electrically conducting the stimulating component 31 to the circuit board 54. Thus, the circuit board 54 is able to delivery power to the stimulating component 31 from a battery. When the first shell 12 is removed from the second shell 13, the first conductive component 52 is separated from the second conductive component 53, and the stimulating component 31 is automatically disconnected from the power supply, which reduces the possibility of a short-circuit or leakage, and the product is safer to use.

Specifically, the stimulating component 31 includes, but is not limited to a vibration motor 60, an electric heater, a temperature control sensor, a haptic sensor, or a light emitter, etc. Exemplarily, in one embodiment of the present disclosure, referring to FIGS. 3 and 4, the stimulating component 31 is a vibration motor 60, which generates high-frequency vibration and provides a greater stimulation effect for the testicles.

The electrical connection between the first conductive component 52 and the circuit board 54 may be, but are not limited to, wired power supply realized by flexible cables, wireless power supply realized by electromagnetic induction, or the like. Similarly, the electrical connection between the second conductive component 53 and the vibration motor 60 may be, but are not limited to, wired power supply realized by flexible cables, wireless power supply realized by electromagnetic induction, or the like.

In one embodiment of the present disclosure, at least one vibration motor 60 is provided in the first massage element 20. Specifically, the at least one vibration motor 60 is arranged at an end of the first massage element 20 away from the opening 22. The high-frequency vibration generated by the at least one vibration motor 60 received in the first massage element 20 provides a more intense stimulation effect for the penis and improving the user's experience. In the illustrated embodiment, a vibration motor 60 is embedded in the first massage element 20. In other embodiments, a vibration motor 60 may also be attached to the outer wall of the first massage element 20. In addition, the at least one vibration motor 60 may be arranged at the end of the first massage element 20, alternatively, the at least one vibration motor 60 may be arranged at a circumferential outer wall of the first massage element 20.

In one embodiment of the present disclosure, the sexual stimulation device 100 further includes a battery 51 electrically connected to the circuit board 54 and the motor 41, respectively. The casing 10, which may specifically be the second shell 13, is provided with a control button, by which the users can control the motor 41, such as start/stop, rotation direction switching, adjusting the speed, etc., as well as controlling the at least one vibration motor 60, such as start/stop, vibrating frequency, and the like.

In one embodiment of the present disclosure, the battery 51 may be detachable from the casing 10 for easy replacement. Further, the battery 51 may be a rechargeable battery fixed within the second shell 13.

In one embodiment of the present disclosure, one of the first and second conductive components 52, 53 is a conductive plug 521, and the other of the first and second conductive components 52, 53 is a conductive socket 531, and the two are electrically connected by plugging in. That is, in the case where the first conductive component 52 is the conductive plug 521, the second conductive component 53 is the conductive socket 531 mateable with the conductive plug 521. In the case where the second conductive component 53 is the conductive plug 521, the first conductive component 52 is the conductive socket 531 mateable with the conductive plug 521.

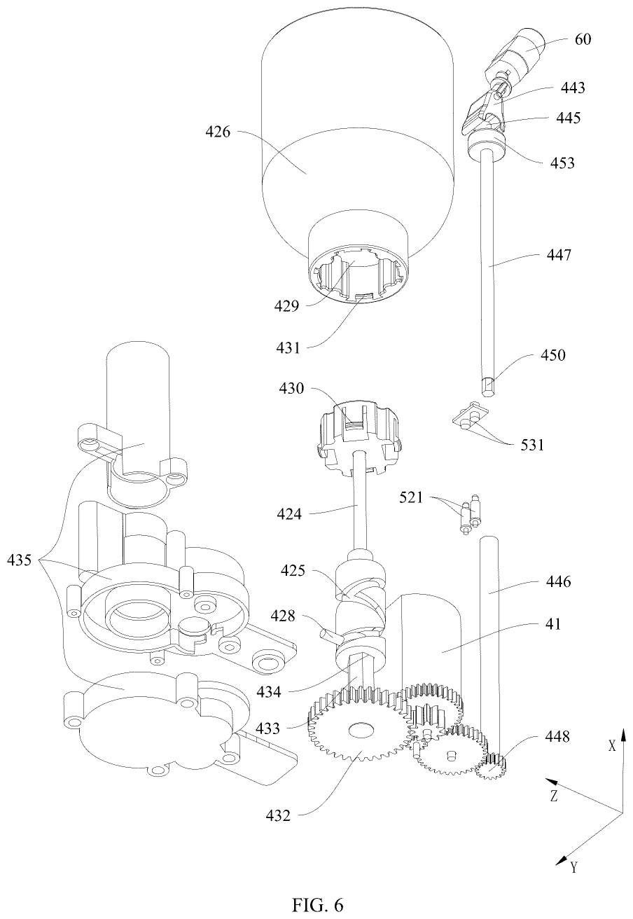

Exemplarily, referring to FIGS. 4 and 6, the first conductive component 52 is a conductive plug 521 positioned at an end of the second shell 13 toward the first shell 12, the second conductive component 53 is the conductive socket 531 positioned at an end of the first shell 12 toward the second shell 13. When the first shell 12 is connected to the second shell 13, the conductive plug 521 is plugged into the conductive socket 531 to achieve electrical conduction. When the first shell 12 is separated from the second shell 13, the conductive plug 521 is pulled out from the conductive socket 531. The sexual stimulation device 100 of the present disclosure realizes automatic connection or disconnection of the conductive plug 521 with the conductive socket 531 in the case where the first shell 12 and the second shell 13 are connected or detached, which is safer in use and more convenient in assembly.

Alternatively, the first and second conductive components 52, 53 may be electrical contact pads. Preferable, at least one of the electrical contact pads is resilient mounted and biased by a spring. As such, when the first the second conductive components 52, 53 are connected, the spring is compressed to provide a force to maintain stable contact between the first and second conductive components 52, 53.

In one embodiment of the present disclosure, referring to FIGS. 3 and 4, the casing 10 further includes a partition 14, a first inner cavity 121 of the first shell 12 and a second inner cavity 131 of the second shell 13 are separated by the partition 14. Specifically, the partition 14 is substantially a plate-like structure adapted to the size of the inner wall of the casing 10. The partition 14 separates the inner cavity 121 of the first shell 12 from the inner cavity 131 of the second shell 13, which not only effectively prevents water vapor, dust, and the like from entering the second shell 13 to impact on electrical safety, but also prevents the components in each of the first and second shell 12, 13 from interfering with each other to a certain extent, thereby ensuring the working reliability of the product.

The first shell 12 further includes a first lumen 122 located at one side of and spaced from its first inner cavity 121, the second shell 13 further includes a second lumen 132 located at one side of and spaced apart from its second inner cavity 131. The first lumen 122 and the second lumen 132 both extend in the longitudinal direction. When the first shell 12 and the second shell 13 are connected, the first lumen 122 and the second lumen 132 are communicated to form a passage 16. In particular, the first lumen 122 has a volume much smaller than the first inner cavity 121, and the second lumen 132 has a volume much smaller than the second cavity 131.

In this embodiment, each of the first and the second shell 12, 13 has a substantially cylindrical main body and a column provided at an outer periphery of the main body, The inner cavity 121, 131 of each of the first shell 12 and the second shell 13 is defined in the main body, and the lumen 122, 132 of each of the first shell and the second shell is defined in the column. In particular, the column has a length equal to the length of the main body, with two longitudinal ends respectively flushed with the two longitudinal ends of the first shell. The column has a diameter much smaller than the diameter of the main body.

In one embodiment of the present disclosure, referring to FIG. 4, the driving assembly 40 includes a motor 41 mounted in the second shell 13, a first transmission unit 42 connected between the motor 41 and the first massage element 20, and a second transmission unit 44 connected between the motor 41 and the second massage element 30. The first transmission unit 42 is configured to drive the first massage element 20 to move and/or rotate relative to the first shell 12. The second transmission unit 44 is configured to drive the second massage element 30 to swing and/or rotate relative to the first shell 12. That is, in this embodiment, the movements of the first and second massage elements 20, 30 are actuated by the same motor 41, and the overall product structure is more compact.

In one embodiment of the present disclosure, the first transmission unit 42 includes a first gear transmission set 421, a first transmission shaft 422 and a first support member 426. The first support member 426 is located in the first inner cavity 121 of the first shell 12 and fixed to the first massage element 20. Specifically, in one embodiment, the first support member 426 is made of a hard material, including but not limited to hard plastics such as polypropylene (PP), polyvinyl chloride (PVC), polycarbonate (PC), etc. Its hardness is greater than a hardness of the first massage element 20, so as to provide support and fixing for the first massage element 20, which is also beneficial for the transmission of power between the motor 41 and the first massage element 20.

Referring to FIG. 3, the first support member 426 is a sleeve adapted to the external contour of the first massage element 20 in the circumferential direction, and the first support member 426 encircles the exterior of the first massage element 20. In other words, the first support member 426 is mounted around the first massage element 20 to support and drive the first massage element 20.

In one embodiment of the present disclosure, the first transmission shaft 422 has a first end 422a and a second end 422b opposite to the first end 422a. The first transmission shaft 422 extends out of the second shell 13 into the first shell 12, with the first end 422a arranged in the first shell 12 and the second end 422b arranged in the second shell 13. The first end 422a of the first transmission shaft 422 is fixed to the first support member 426. The first gear transmission set 421 is connected between the motor 41 and the second end 422b of the first transmission shaft 422.

Referring to FIG. 3, along the longitudinal direction, the center of the partition 14 has a perforation 141, and the first transmission shaft 422 extends through the perforation 141 with the first end 422a fixed to an end of the first support member 426 adjacent to the partition 14. In this embodiment, the first gear transmission set 421 includes a plurality of gears meshing with each other, and the motor 41 drives the first transmission shaft 422 to rotate through the first gear transmission set 421.

The above arrangement has some advantages as follows. On the one hand, it enables all three of the first transmission shaft 422, the first support member 426 and the first massage element 20 to simultaneously rotate about an axis in the longitudinal direction. On the other hand, the first gear transmission set 421 is able to transmit and adjust the torque and rotational speed of the first transmission shaft 422, thereby ensuring that first massage element 20 can still operate smoothly under different loading conditions by optimizing the power distribution, and avoiding abnormal movements caused by insufficient torque or too high rotational speed.

In other embodiments of the present disclosure, the first support member 426 is partially embedded in the first massage element 20. That is, the first support member 426 may also be arranged inside the first massage element 20, so as to provide better support for the first massage element 20.

In other embodiments of the present disclosure, the first transmission unit 42 may also be a worm gear mechanism, etc., which is also able to drive the first transmission shaft 422 which in turn drives the first massage element 20 to rotate.

In other embodiments of the present disclosure, the first transmission unit 42 may also be a rack and pinion mechanism, a screw mechanism, etc., which is also able to drive the first transmission shaft 422 which in turn drives the first massage element 20 to translate in the axial direction.

In one embodiment of the present disclosure, referring to FIGS. 3, 5 and 6, the first end 422a of the first transmission shaft 422 is connected to a connecting block 427 and the first support member 426 is detachably connected to the connecting block 427. Exemplarily, the first end of the first transmission shaft 422 is inserted into the connecting block 427 and fastened with screws. The first support member 426 has a closed end facing towards the first transmission shaft 422. The closed end of the first support member 426 has a socket portion 429 that has a recess 429a opening towards the first transmission shaft 422, and the connecting block 427 is detachably engaged within the socket portion 429. In this way, the first massage element 20 together with the first support member 426 can be removed through the mounting opening 11 of the first shell 12, thereby facilitating cleaning, maintenance and replacement for the first massage element 20.

The means by which the socket portion 429 of the first support member 426 is detachably connected to the connecting block 427 include, but are not limited to, snap-fit connection, threaded connection, magnetic connection, form-fit connection, etc.

Exemplarily, in one embodiment, referring to FIG. 6, an outer peripheral wall of the connecting block 427 is provided with one or more first hooks 430. The first hooks 430 are spaced apart in a circumferential direction, and an inner peripheral wall of the socket portion 429 is provided with one or more second hooks 431 corresponding to the one or more first hooks 430 respectively, and the second hooks 431 are spaced apart correspondingly. The first hooks 430 and the second hooks 431 are detachably connected such that the connecting block 427 is detachably connected to the socket portion 429.

In one embodiment of the present disclosure, referring to FIG. 6, a sectional contour of the outer peripheral wall of the connecting block 427 is non-circular, and a sectional contour of the inner peripheral wall of the socket portion 429 is adapted to the sectional contour of the outer peripheral wall of the connecting block 427, so that a form-fit connection between the two can be realized by the connecting block 427 engaged in the socket portion 429.

In one embodiment of the present disclosure, referring to FIGS. 3, 5 and 6, the first transmission shaft 422 includes a first shaft rod 423 and a second shaft rod 424 slidably connected to the first shaft rod 423. The first shaft rod 423 is connected to the first gear transmission set 421, the second shaft rod 424 is connected to the first support member 426. The second shaft rod 424 is provided with a first groove 425 extending spirally. A pin slider 428 is fixedly mounted in the second shell 13, and is slidably engaged with the first groove 425. That is, the engagement of the pin slider 428 which is fixed relative to the second shell 13, and the first groove 425 which rotates relative to the second shell 13, can drive the second shaft rod 424 not only to rotate with the first shaft rod 423, but also to move in the axial direction. In this way, the first massage element 20 is not only able to rotate, but is also able to move in the axial direction, thereby rubbing the outer surface of the penis in both the circumferential and axial directions, and generating an enhanced stimulation effect.

Specifically, the first shaft rod 423 has a first gear portion 432 and a first polygon shaft 433 connected with each other. The first gear portion 432 is fixed at a longitudinal end of the first polygon shaft 433. The first gear transmission set 421 is engaged with the first gear portion 432.

The second shaft rod 424 includes a first sleeve portion 434 and a connecting shaft 436 connected each other. The first sleeve portion 434 is arranged in one longitudinal end of the connecting shaft and in form-fit connection with the first polygon shaft 433 of the first shaft rod 423. In particular, a contour of an inner peripheral wall of the first sleeve portion 434 is adapted to a contour of the first polygon shaft 433, and the first polygon shaft 433 can be slidably engaged in the first sleeve portion 434 along the longitudinal direction. The other longitudinal end of the connecting shaft 436 is fixed to the connecting block 427 with screws. An outer peripheral wall of the first sleeve portion 434 is provided with the first groove 425.

The first transmission unit 42 further includes an inner housing 435 and the pin slider 428, the first gear transmission set 421 and the first transmission shaft 422 are both received in the inner housing 435, the inner housing 435 is fixed in the second shell 13, one end of the pin slider 428 is fixed to the inner housing 435, the other end of the pin slider 428 is slidably engaged into the first groove 425.

By the engagement of the first polygon shaft 433 and the first sleeve portion 434, the first shaft rod 423 is able to drive the second shaft rod 424 to rotate. As the second shaft rod 424 rotates, the pin slider 428 fixed to the second shell 13 slides within the first groove 425, thereby driving the second shaft rod 424 to reciprocate along the longitudinal direction. The second shaft rod 424 is connected to the connecting block 427, which is connected to the first support member 426. The first support member 426 in turn is connected to the first massage element 20, allowing the first massage element 20 not only to rotate with the second shaft rod 424 but also to reciprocate along the longitudinal direction.

In one embodiment of the present disclosure, referring to FIGS. 3, 5, 6 and 7, the second transmission unit 44 includes a second gear transmission set 441, a second transmission shaft 442 and a second support member 443. The second support member 443 is at least partially engaged in the second massage element 30 and provided with a connection end, in this embodiment, the connection end is a slot 444. The second transmission shaft 442 has a first end 442a extending out of the second shell 13 and is connected with a third shaft rod 445. The third shaft rod 445 is arranged eccentrically relative to a rotation axis of the second transmission shaft 442. The third shaft rod 445 is slidably inserted into the slot 444, the second gear transmission set 441 is connected between the motor 41 and a second end 442b of the second transmission shaft 442. By the engagement of the third shaft rod 445 and the slot 444, the second support member 443 drives the second massage element 30 to swing.

Specifically, the second transmission shaft 442 is arranged on the radial outer side of the first transmission shaft 422. Exemplarily, the second transmission shaft 442 is parallel to the first transmission shaft 422, and in the illustrated embodiment, the second transmission shaft 442 is arranged in the passage 16 constituted by the first and second lumen 122, 123 and parallel to the vertical side of the first transmission shaft 422, wherein the vertical direction is the Z-direction as shown in FIGS. 3 to 7, and the vertical direction is perpendicular to the longitudinal direction. The second transmission shaft 442 includes a first section 446 positioned in the second shell 13 and a second section 447 positioned in the first shell 12. The first section 446 extends along the longitudinal direction and includes a second gear portion 448 engaged with the second gear transmission set 441 and a second sleeve portion 449. The second section 447 extends along the longitudinal direction and includes a second polygon shaft 450 inserted into the second sleeve portion 449. The second sleeve portion 449 is in form-fit connection with the second polygon shaft 450 of the second section 447. The contour of an inner peripheral wall of the second sleeve portion 449 is adapted with a contour of the second polygon shaft 450. A torque transmission connection between the first section 446 and the second section 447 is achieved by means of the inserted engagement of the second sleeve portion 449 and the second polygon shaft 450.

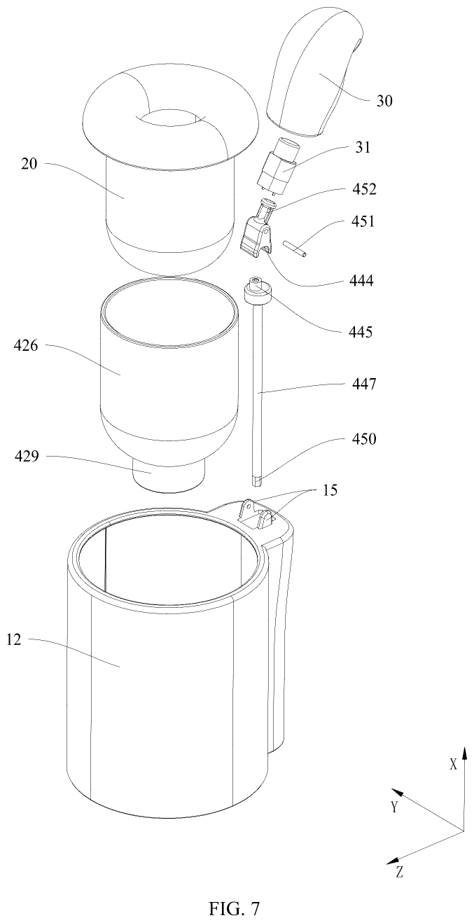

In one embodiment of the present disclosure, referring to FIGS. 3 and 7, along the longitudinal direction, the second transmission shaft 442 further includes a wheel 453 provided between the third shaft rod 445 and the second section 447, the wheel 453 is in torque transmission connection with the second section 447, one end of the third shaft rod 445 is fixed to the wheel 453, the other end of the third shaft rod 445 is movably inserted into the slot 444. A center axis of the third shaft rod 445 is arranged eccentrically relative to a rotation axis of the second section 447, so that the third shaft rod 445 revolves around the rotation axis of the second section 447.

In some embodiments, the third shaft rod 445 and the wheel 453 are formed as one-piece structure. In some embodiments, the wheel 453 and the second section 447 are a one-piece structure. In some embodiments, when the diameter of the second section 447 is large enough, the third shaft rod 445 can be molded or fixed directly to the second section 447, thereby omitting the wheel 453.

By the inserted engagement of the second polygon shaft 450 and the second sleeve portion 449, the first section 446 drives the second section 447 to rotate. The rotation of the second section 447 drives the wheel 453, which in turn drives the third shaft rod 445 to revolve around the rotation axis of the second section 447. The third shaft rod 445 is inserted into the slot 444, thereby causing the second support member 443 to rotate along with the third shaft rod 445 and/or swing.

In one embodiment of the present disclosure, a swinging axis L2 of the second massage element 30 is substantially perpendicular to the central longitudinal axis L1 of the massage space 21. Specifically, the second support member 443 is pivotally connected to the first shell 12 via a pin shaft 451, i.e. the pin shaft 451 serves as the swinging axis L2 of the second massage element 30. The slot 444 is a lateral slot which is perpendicular to the third shaft rod 445 and extends along a lateral direction, wherein the lateral direction is the Y-direction as shown in FIGS. 4 to 7. The pin shaft 451 is parallel to the extension direction of the slot 444 and spaced at a certain distance. Exemplarily, referring to FIGS. 3 and 7, the pin shaft 451 is substantially connected to the middle part of the second support member 443. One end of the second support member 443 away from the slot 444 acts as the swing end 452, which is embedded into the second massage element 30. As shown in FIGS. 3 to 7, the third shaft rod 445 extends along the X-direction, while the slot 444 and pin shaft 451 extend along the Y-direction, thereby driving the second massage element 30 to reciprocate and swing around the pin shaft 451 as the center within the XZ plane.

In one embodiment of the present disclosure, the casing 10 further includes two hanging lugs 15 arranged opposite to each other, and two ends of the pin shaft 451 are respectively inserted into the two hanging lugs 15. Optionally, the pin shaft 451 is fixed to the second massage element 30, and the two ends of the pin shaft 451 are rotatably engaged with the two hanging lugs 15, respectively. Alternatively, the two ends of the pin shaft 451 are fixed to the two hanging lugs 15, respectively, and the second massage element 30 is rotatably engaged with the pin shaft 451. As the third shaft rod 445 revolves around the rotation axis of the second section 447, it generates displacement in both the Y-direction and the Z-direction. The movement of the third shaft rod 445 in the Y-direction causes it to slide along the slot 444, while its movement in the Z-direction drives the second support member 443 to move in the Z-direction. Due to the position constraint imposed by the pin shaft 451 on the second support member 443, the second support member 443 reciprocates and swings around the pin shaft 451. The swing end 452 thereof embedded into the second massage element 30 causes the second massage element 30 to reciprocate and swing around the pin shaft 451.

In one embodiment of the present disclosure, the second support member 443 swings about the pin shaft 451 between a first extreme position and a second extreme position, with an angle between the first position and the second position being ranged between 5° and 120°. Within this angle range, the second support member 443 drives the second massage element 30 to swing by an optimal amplitude, thereby enhancing the massage effect on the region adjacent to the penis such as the testicles and perineum.

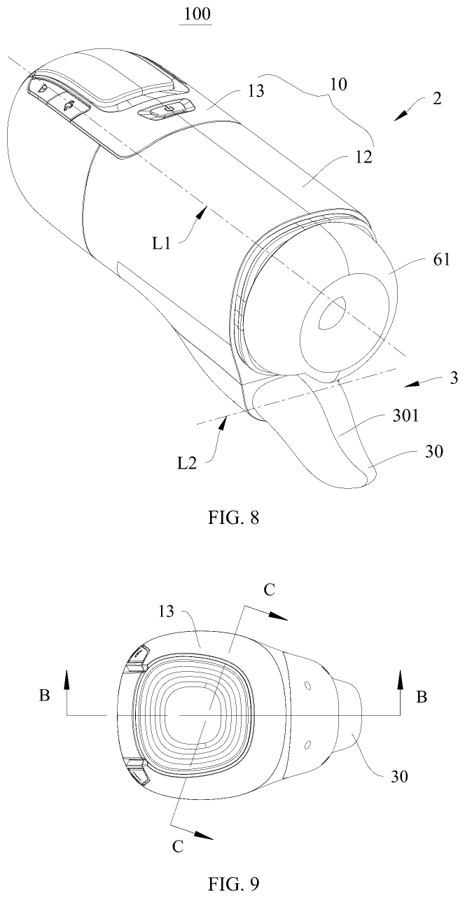

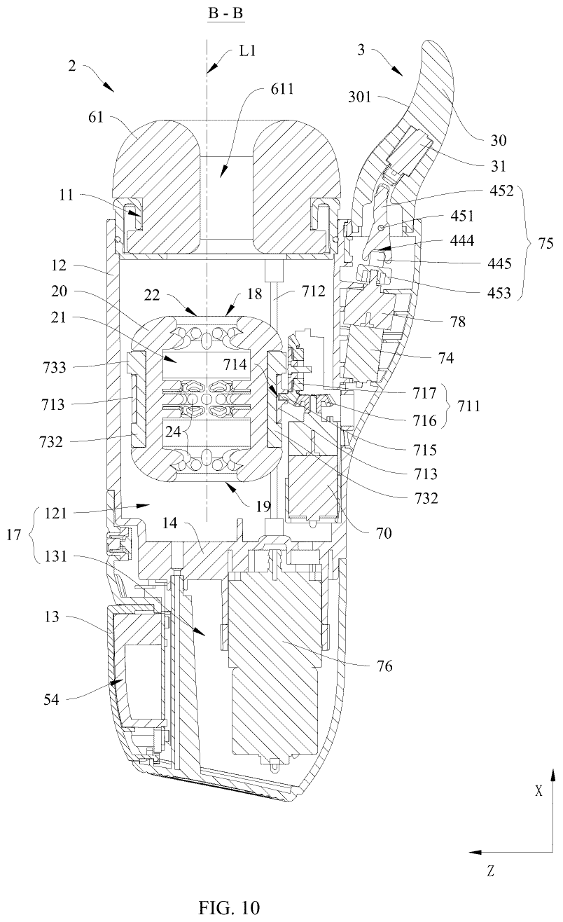

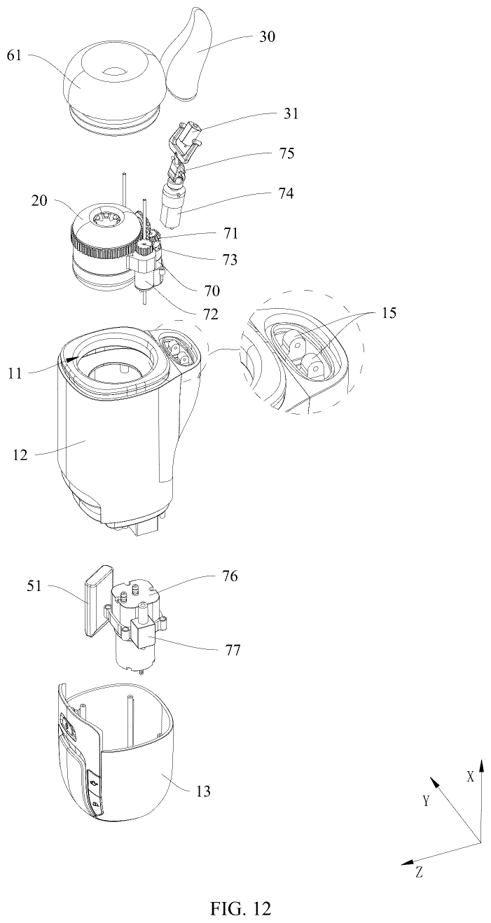

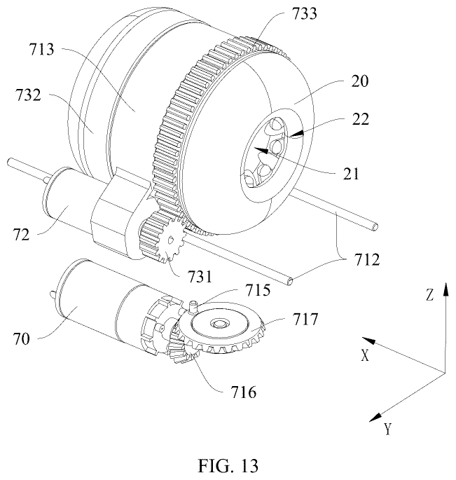

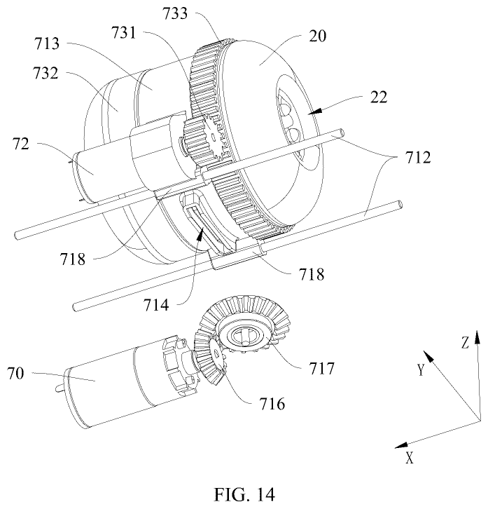

In other embodiments of the present disclosure, referring to FIGS. 8 to 12, the movements of the first and second massage elements 20, 30 may be actuated by different actuators, such as different motors, so that each massage element 20, 30 can be controlled independently, which is more flexible in use. To independently control the movement of the first massage element 20, referring to FIGS. 10, 12 to 14, the driving assembly 40 includes a first motor 70 and a first transmission unit 71 connected between the first motor 70 and the first massage element 20. The first transmission unit 71 is configured to drive the first massage element 20 to move relative to the casing 10. Both the first motor 70 and the first transmission unit 71 are arranged within the first inner cavity 121 of the first shell 12.

Specifically, the first transmission unit 71 includes a first gear transmission set 711 connected to the first motor 70, at least one guide rail 712, and a support 713 slidably mounted on the at least one guide rail 712. Preferably, the at least one guide rail 712 includes two guide rails 712 extending along the X-direction and arranged parallel to each other with a spacing along the Y-direction. The support 713 has two sliding blocks 718 with through-holes correspondingly provided on opposite sides along the Y-direction. Each guide rail 712 is slidably engaged with the through-hole of one sliding block 718, enabling the support 713 to slide along the X-direction on the two guide rails 712.

Further, the first massage element 20 is fixedly mounted on the support 713. Preferably, the support 713 is substantially annular and mounted around the periphery of the first massage element 20 to fix the first massage element 20 to the support 713. In this embodiment, the massage space 21 of the first massage element 20 has openings at both ends along the X-direction.

Preferably, the inner wall of the massage space 21 is provided with multiple granular bumps 24. These granular bumps 24 increase friction between the inner wall of the massage space 21 and the penis, thereby enhancing the stimulating effect.

Additionally, the support 713 has a groove 714 extending in a direction intersecting the at least one guide rail 712. The first gear transmission set 711 includes a protrusion 715 slidably arranged in the groove 714. Preferably, the groove 714 extends between the two guide rails along the Y-direction, which is perpendicular to the sliding direction (X-direction) of the first massage element 20. The first motor 70 drives the protrusion 715 of the first gear transmission set 711 to revolve around a rotation axis parallel to the Z-direction, causing the protrusion 715 to displace in both the X- and Y-directions. The Y-direction displacement allows the protrusion 715 to slide along the groove 714, while the Z-direction displacement drives the support 713 through its engagement with the groove 714 to reciprocate along the X-direction on the guide rails 712, thereby enabling the first massage element 20 to slide reciprocally along the X-direction.

In one embodiment of the present disclosure, the first gear transmission set 711 includes a first bevel gear 716 and a second bevel gear 717. The first bevel gear 716 is in torque transmission connection with the output shaft of the first motor 70 and meshes with the second bevel gear 717. Preferably, the rotation axis of the first bevel gear 716 extends along the X-direction. The rotation axes of the first bevel gear 716 and the second bevel gear 717 are perpendicular to each other, i.e., the rotation axis of the second bevel gear extends along the Z-direction. The protrusion 715 is a rod extending along the Z-direction and eccentrically arranged on the second bevel gear 717.

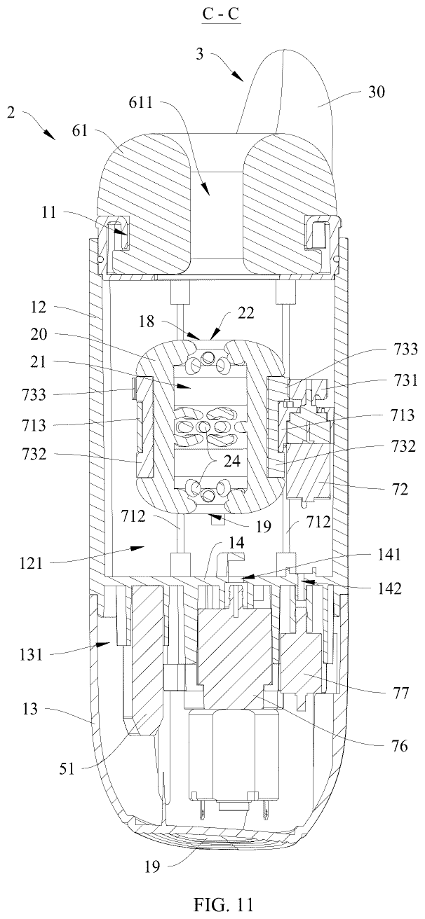

In one embodiment of the present disclosure, referring to FIGS. 11 to 14, the driving assembly 40 further includes a second motor 72 and a second transmission unit 73 connected between the second motor 72 and the first massage element 20. The second transmission unit 73 drives the first massage element 20 to rotate relative to the casing 10. Specifically, both the second motor 72 and the second transmission unit 73 are arranged within the first inner cavity 121 of the first shell 12.

The second transmission unit 73 includes an output gear 731 in torque transmission connection with the second motor 72 and a ferrule 732 having a gear portion 733. The rotation axis of the output gear 731 extends along the X-direction. The ferrule 732 is mounted around the first massage element 20 and interference-fitted to the first massage element 20 circumferentially. The gear portion 733 meshes with the output gear 731, and its rotation axis is parallel to that of the output gear 731. That is, the second motor 72 drives the output gear 731 to rotate about the X-direction, which in turn rotates the gear portion 733 meshed with the output gear 731 about the X-direction (i.e. the ferrule 732 rotates about the X-direction), and consequently drives the first massage element 20 to rotate about the X-direction.

Further, the annular support 713 is mounted on the ferrule 732 and rotatable relative to the ferrule 732 in such a manner that an axial movement of the support 713 relative to the ferrule 732 along the X-direction is limited while relative rotation between the support 713 and the ferrule 732 is allowed. In particular, an outer periphery of the ferrule 732 has an annular groove, the support 713 is rotatable engaged in the annular groove with a circumferential gap therebetween. Preferably, the axial length of the annular groove in the X-direction is substantially equal to or slightly larger than the axial length of the support 713 in the same direction.

The second motor 72 is fixed to the support 713, particularly on its outer periphery. In other words, both the second motor 72 and the second transmission unit 73 are mounted on the support 713 and move synchronously with it along the X-direction. Meanwhile, driven by the second motor 72 via the output gear 731, the ferrule 732 can rotate relative to the support 713. This configuration enables the first massage element 20 to achieve reciprocating linear motion along the X-direction, rotational motion about the X-direction or both.

In alternative embodiments, the first massage element 20 may only rotate about the X-direction. In this case, the second motor 72 may be fixed directly to the casing 10, preferably the first shell 12, to drive the first massage element 20 to rotate independently via the second transmission unit 73.

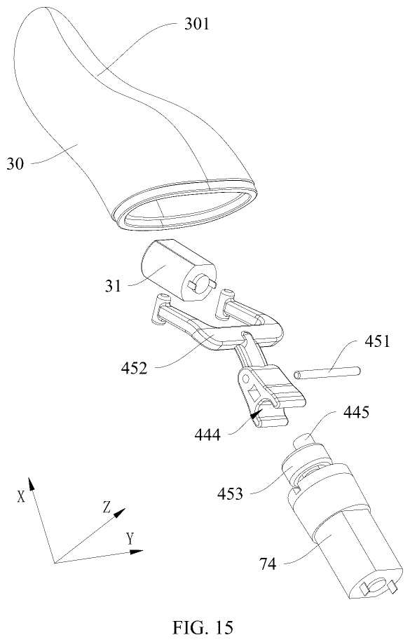

In one embodiment of the present disclosure, referring to FIGS. 10, 12 and 15, to independently control the second massage element 30, the driving assembly 40 further includes a third motor 74 and a third transmission unit 75 connected between the third motor 74 and the second massage element 30. The third transmission unit 75 drives the second massage element 30 to swing and/or rotate relative to the casing 10.

Specifically, the third transmission unit 75 drives the second massage element 30 to reciprocally swing and/or rotate towards or away from the central longitudinal axis L1 of the massage space 21. Thus, the second massage element 30 can massage the region adjacent to the penis by periodically tapping the region adjacent to the penis through swinging or rotating motions.

Preferably, the second massage element 30 reciprocally swings or rotates between a first extreme position closer to the central longitudinal axis LI of the massage space 21, and a second extreme position farther away from the central longitudinal axis LI of the massage space 21. In some embodiments, the first extreme position overlaps with the massage space 21 viewed along the longitudinal axis L1 of the massage space 21. In other embodiments, a distance between the second massage element 30 and the longitudinal axis L1 of the massage space 21 is in a range of 0˜200 mm.

In one embodiment of the present disclosure, the driving assembly 40 further includes a gearbox 78 connected between the third motor 74 and the third transmission unit 75. One end of the gearbox 78 is connected to the output shaft of the third motor 74, the other end of the gearbox 78 is connected to the third transmission unit 75 and transmits the torque to the third transmission unit 75. As such, the second massage element 30 can move with a smaller speed than the third motor and a higher torque, thereby providing stronger stimulations with a clear rhythm to the user at the region adjacent to the penis. In particular, the second massage may swing by 30-1000 times/cycles per one minute according to multiple levels set by the circuit board 54, which corresponds to the multiple speeds of the third motor 74.

Specifically, the third motor 74, the gearbox 78 and the third transmission unit 75 are arranged within the first shell 12. The third transmission unit 75 includes a wheel 453 in torque transmission connection with the third motor 74, a shaft rod 445, and a support member 443. The shaft rod 445 is eccentrically mounted on the wheel 453 relative to its rotation axis. The support member 443 is at least partially engaged in the second massage element 30 and provided with a slot 444. The third shaft rod 445 is slidably engaged into the slot 444.

That is, the third transmission unit 75 drives the second massage element 30 to swing and/or rotate in a manner similar to the second transmission unit 44, except for the difference that the output shaft of the third motor 74 directly drives the wheel 453 to rotate, causing the shaft rod 445 to revolve around the rotation axis of the wheel 453. The shaft rod 445 is slidably inserted into the slot 444, thereby making the support member 443 swing though the motion of the third shaft rod 445, which in turn drives the second massage element 30 to swing.

For specific details regarding how the shaft rod 445 drives the swinging motion of the second massage element 30, please refer to the description of the third shaft rod 445 in the preceding embodiments, and it will not be repeated here.

In one embodiment of the present disclosure, referring to FIGS. 10 to 12, the sexual stimulation device 100 further includes a negative pressure generator 76 arranged within the first massage component 2, preferably the mounting space 17 of the casing 10, and configured to change air pressure inside the first massage component 2.

Specifically, the first massage element 20 is positioned within the first inner cavity 121 of the first shell 12. The negative pressure generator 76 is mounted in the second inner cavity 131 of the second shell 13. The opening 22 of the first massage element 20 is aligned with the mounting opening 11 along the X-direction, enabling the penis to be inserted into the massage space 21 through the mounting opening 11 and the opening 22 one after another. The partition 14 between the second shell 13 and the first shell 12 is provided with a suction port 142. When the negative pressure generator 76 is activated, it extracts air directly from the first inner cavity 121 of the first shell 12 through the suction port 142 and discharges it to the exterior of the casing 10. The pressure difference provides a suction effect to the penis, which increasing stimulation to the penis.

Preferably, the sexual stimulation device 100 further includes a lip 61 covering the mounting opening 11. The lip 61 has an insertion channel 611 that connects the first inner cavity 121 with the exterior of the casing 10, allowing the penis to extend into the massage space 21 through the insertion channel 611 and the opening 22 one after another. When the penis is placed within the massage space 21, the lip 61 made of a soft material surrounds the periphery of the penis to ensure airtightness of the first inner cavity 121.

Furthermore, the sexual stimulation device 100 includes a valve 77 disposed within the second inner cavity 131. The partition 14 between the second shell 13 and the first shell 12 is provided with an intake port 143. The valve 77 communicates with the intake port 143 at one end and communicates with the exterior of the casing 10 at the other end, thereby opening or closing air passage between the first inner cavity 121 and the exterior of the casing 10.

Specifically, the valve 77 has an open state and a closed state. During use, the valve 77 remains closed while the air exhausts from the first inner cavity 121, gradually reducing the internal pressure of the first inner cavity 121. After use, the negative pressure generator 76 stops, and the valve 77 switches to the open state, allowing external gas to rapidly flow into the first inner cavity 121, so as to quickly equalize the internal pressure with the external pressure, facilitating withdrawal of the penis from the first inner cavity 121. The valve 77 can be operated either electrically or manually.

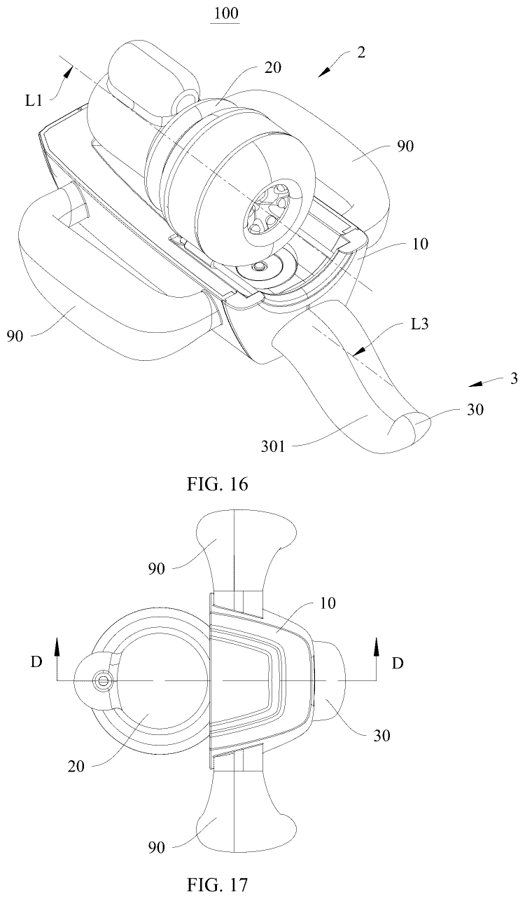

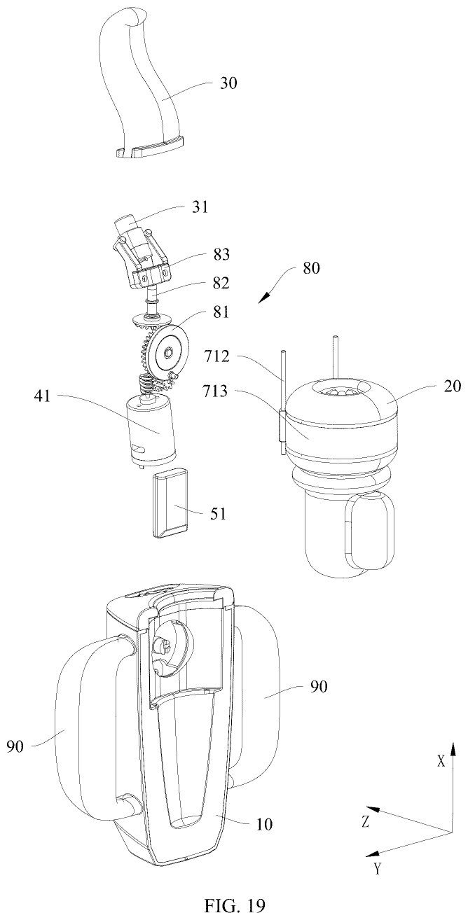

In yet another embodiment of the present disclosure, referring to FIGS. 16 to 19, the first massage member 20 of the first massage component 2 is at least partially arranged outside the casing 10, while the second massage member 30 provides swaying stimulation to the region adjacent to the penis. In this embodiment, the driving assembly 40 includes a motor 41 and a transmission unit 80 connected between the motor 41 and the second massage element 30. Specifically, the transmission unit 80 includes a curved shaft 82 and a gear transmission set 81. The curved shaft 82 is at least partially engaged in the second massage element 30. The gear transmission set 81 is configured to drive the curved shaft 82 to rotate along a rotation axis L3 relative to the casing 10. A portion of the curved shaft 82 is inclined relative to the rotation axis L3.

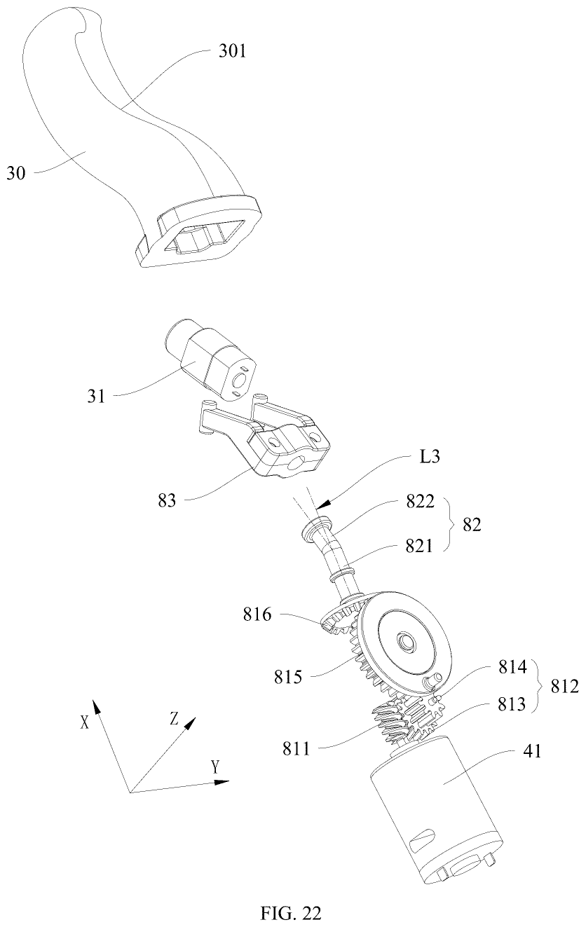

Preferably, referring to FIGS. 16, 18 and 22, the curved shaft 82 includes a transition segment 821 extending along the rotation axis L3 and a swaying segment 822 extending obliquely to the rotation axis L3. The transition segment 821 is connected between the swaying segment 822 and the gear transmission set 81. The swaying segment 822 extends into the second massage element 30. The rotation of the swaying segment 822 about the rotation axis L3 drives the second massage element 30 to rotate about the rotation axis L3, and a track T of the second massage element 30 is substantially a conical surface around the rotation axis L3.

In addition, the transmission unit 80 further includes a support member 83 embedded in the second massage element 30. The swaying segment 822 is rotatable engaged within the support member 83. In this embodiment, the rotation axis L3 of the curved shaft 82 is substantially parallel to the central longitudinal axis L1 (i.e., the X-direction). Therefore, during the process of the second massage element 30 moving along the track T, the second massage element 30 enables periodic motion in both the Y-, Z-directions, thus achieving swaying stimulation in the Y-, Z-directions. In other embodiments, the rotation axis L3 of the curved shaft 82 may form an angle with the central longitudinal axis L1.

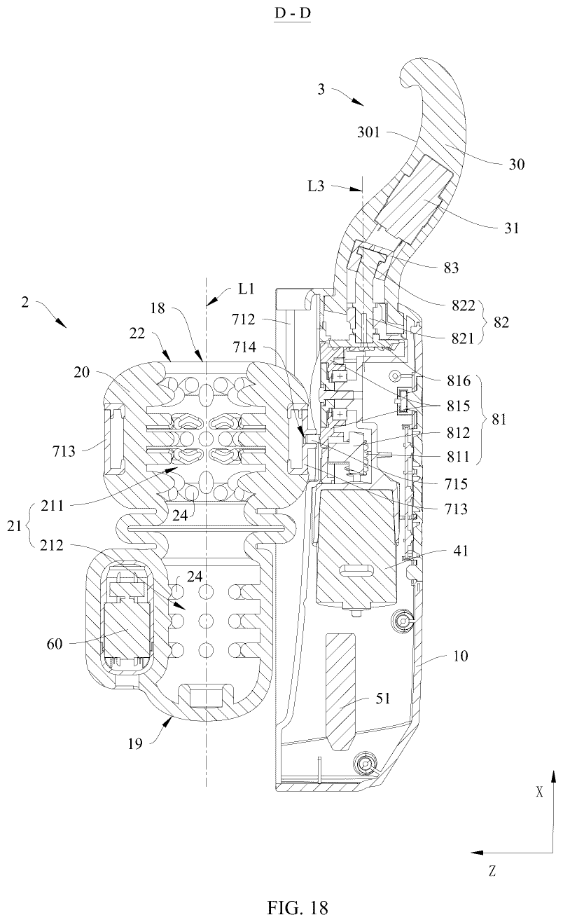

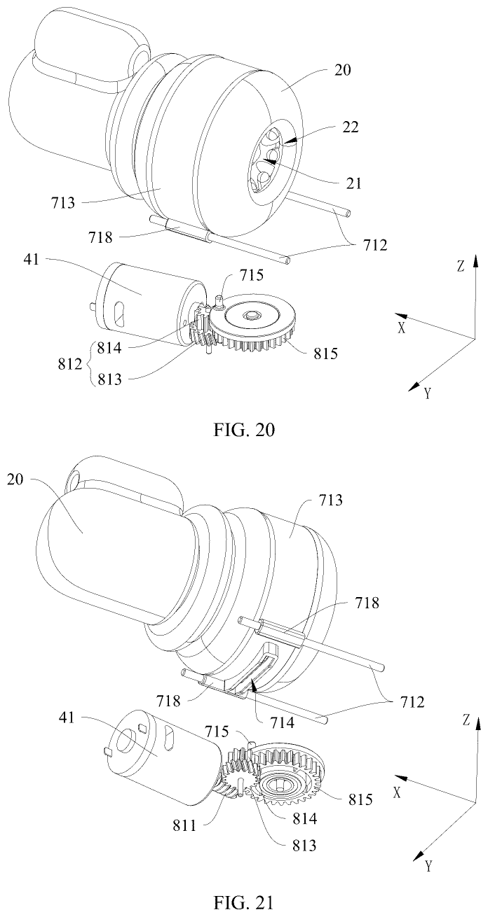

In one embodiment of the present disclosure, referring to FIGS. 18 to 22, the gear transmission set 81 includes a worm 811, a worm gear 812, a first driving gear 815, and a second driving gear 816. The worm 811 is in torque transmission connection between the motor 41 and the worm gear 812. The first driving gear 815 is meshed between the worm gear 812 and the second driving gear 816. The first driving gear 815 includes a protrusion 715 for driving the first massage element 20 to slide. The second driving gear 816 is in torque transmission connection with the curved shaft 82. That is, through the gear transmission set 81, the motor 41 can drive both the first massage element 20 to slide and the second massage element 30 to rotate simultaneously.

Specifically, the worm 811 is in torque transmission connection with the output shaft of the motor 41. The rotation axis of the worm gear 812 (Z-direction) is perpendicular to the extension direction of the worm 811. The worm gear 812 includes a first gear portion 813 meshed with the worm 811 and a second gear portion 814 meshed with the first driving gear 815. The first driving gear 815 is a cylindrical gear with its rotation axis parallel to the Z-direction. The protrusion 715 is a pin eccentrically arranged on the first driving gear 815 for driving the first massage element 20 to slide. The second driving gear 816 is a face gear or a bevel gear with its rotation axis parallel to the X-direction. The transition segment 821 of the curved shaft 82 is coaxial with and in torque transmission connection with the second driving gear 816. The torque transmission connection can be achieved by means such as form-fit, interference fit, or the like.

Preferably, referring to FIGS. 16, 20 and 21, the transmission unit 80 includes at least one guide rail 712 and a support 713 slidably mounted on the at least one guide rail 712. The first massage element 20 is mounted on the support 713. The support 713 has a groove 714 extending in a direction intersecting the at least one guide rail 712. The protrusion 715 is slidably engaged in the groove 714. In this embodiment, the arrangements of the support 713, the guide rail 712, and the specific manner in which the protrusion 715 drives the first massage element 20 to slide are substantially the same as those in the embodiment shown in FIGS. 10, 12 to 14. The difference is that, in this embodiment, the first massage element 20, the at least one guide rail 712, and the support 713 are located outside the casing 10.

Preferably, the first massage element 20 is detachably mounted on the support 713 along the X-direction and can be detached from the support 713 for cleaning, thereby facilitating the maintenance and replacement of the first massage element 20 and enhancing the safety and hygiene of the sexual stimulation device 100 while in use.

In this embodiment, referring to FIG. 18, the first massage element 20 is hollow and defines the massage space 21 therein. The opening 22 is defined at the first axial end 18 of the massage space 21, and the second axial end 19 is closed. The opening 22 communicates the massage space 21 with the outside. The massage space 21 includes a first sub-space 211 adjacent to the first axial end 18 and a second sub-space 212 adjacent to the second axial end 19. The first sub-space 211 communicates the opening 22 with the second sub-space 212. The support 713 is mounted around the first massage element 20 and located on the outer periphery of the first sub space 211. A vibration motor 60 is arranged inside the first massage element 20 at one lateral side of the second sub space 212.

In one embodiment of the present disclosure, the sexual stimulation device 100 includes at least one handle 90 disposed on the first massage component 2. Preferably, in this embodiment, referring to FIGS. 16, 17 and 19, the at least one handle 90 includes two handles 90 symmetrically arranged on two opposite sides of the casing 10 in the Y-direction. The handles 90 may be fixedly connected to the casing 10. Optionally, the handles 90 and the casing 10 are formed as a one-piece structure. The user can operate the sexual stimulation device 100 more conveniently by holding the handles 90.

The sexual stimulation device 100 provided by the present disclosure simultaneously massages the penis and the region adjacent to the penis via the first massage component 2 and the second massage component 3. Specifically, the first massage component 2 can massage the penis by means of sliding, rotating, vibrating, pinching or any combinations thereof. The combinations may include, for example, pinching with rotating, or rotating with sliding.

Further, the second massage component 3 can massage the region adjacent to the penis. For example, the second massage component 3 may be provided with one rod that is driven to reciprocally swing about an axis to achieve a tapping stimulation. Alternatively, the rod may be driven to move within a plane where the central longitudinal axis L1 is located or substantially parallel to the central longitudinal axis L1, so that one end of the rod has a predetermined track (e.g. the track is circular, or oval or of any other shape in a loop) to simulate a licking stimulation of tongue.

As another example, the second massage component 3 may be provided with two or more rods that are arranged in couples. The rods of a couple are driven to swing towards or away from each other to simulate a nibbling stimulation of mouth or a pinching stimulation of hand.

Therefore, the two massage components 2, 3 can massage the male genitalia by means of rotating, swing, moving, vibrating, and the like, which has a better effect. It should be understood that the first massage component 2 and the second massage component 3 may also have other forms of movement, as long as they can generate a massage effect on the users, and the present disclosure does not restrict this. In addition, the two massage components 2, 3 may have different forms of movement or may have the same form of movement. The users may start the two massage components 2, 3 simultaneously, or only one of the components 2, 3 as desired during use.

In other embodiments of the present disclosure, the sexual stimulation device 100 may further include a third massage component connected to the first massage component 2 and arranged at the second axial end 19 of the massage space 21 or adjacent to a periphery thereof. The function of the third massage component may be similar to that of the second massage component 3, which can provide a third stimulation on a periphery of a tip of the penis or the glans of the penis.

Finally, it should be noted that: the above merely describes preferred embodiments of the present disclosure without intention to limit the scope of the present disclosure. Although the present disclosure has been described in detail with reference to the foregoing embodiments, for those skilled in the art, the technical solutions described in the foregoing embodiments can still be modified, or some of the technical features can be equally replaced. Any modifications, equivalent replacements, improvements, etc. made within the spirit and principle of the present disclosure should be within the scope of the present disclosure.

1. A sexual stimulation device, comprising:
a first massage component, comprising a first massage element and defining an elongated massage space for accommodating a penis, the massage space having a first axial end for insertion of the penis and a second axial end opposite to the first axial end, at least the first axial end being open;
a second massage component, connected to the first massage component and comprising a second massage element formed in a tongue-like shape, the second massage element being arranged at or adjacent to a periphery of the first axial end of the massage space,
wherein the first massage element is configured to provide a first stimulation to the male penis, and the second massage element is configured to provide a second stimulation to a region adjacent to the male penis.

2. The sexual stimulation device according to claim 1, wherein the sexual stimulation device comprises a driving assembly, the first massage component further comprises a casing, the driving assembly is at least partially received in the casing, the driving assembly is configured to drive the first massage element and/or the second massage element to move relative to the casing.

3. The sexual stimulation device according to claim 1, wherein the massage space is defined by the first massage element, the massage space is substantially cylindrical, the region adjacent to the male penis comprises testicles, perineum, and anus.

4. The sexual stimulation device according to claim 2, wherein the casing comprises a first shell and a second shell detachably connected to each other, the first shell has a first inner cavity, the second shell has a second inner cavity, both the first and second massage elements are mounted to the first shell, the casing further comprises a partition, the partition separates the first inner cavity of the first shell from the second inner cavity of the second shell.

5. The sexual stimulation device according to claim 4, wherein the sexual stimulation device further comprises a circuit board received in the second shell, the second shell is provided with a first conductive component electrically connected to the circuit board, the second massage component is provided with a stimulating component received in the second massage element, the first shell is provided with a second conductive component electrically connected to the stimulating component, the first and second conductive components are connected to each other thereby electrically conducting the stimulating component to the circuit board.

6. The sexual stimulation device according to claim 2, wherein the driving assembly comprises a motor, a first transmission unit connected between the motor and the first massage element, and a second transmission unit connected between the motor and the second massage element, wherein the first transmission unit is configured to drive the first massage element to slide and/or rotate relative to the casing, the second transmission unit is configured to drive the second massage element to swing and/or rotate relative to the casing.

7. The sexual stimulation device according to claim 6, wherein the first transmission unit comprises a first gear transmission set, a first transmission shaft and a first support member, the first support member is fixed to the first massage element, a first end of the first transmission shaft is fixed to the first support member, the first gear transmission set is connected between the motor and a second end of the first transmission shaft.

8. The sexual stimulation device according to claim 6, wherein the second transmission unit comprises a second gear transmission set, a second transmission shaft and a second support member, the second support member is at least partially engaged in the second massage element and provided with a slot, a first end of the second transmission shaft is connected with a shaft rod, the shaft rod is arranged eccentrically relative to a rotation axis of the second transmission shaft, the shaft rod is slidably inserted into the slot, the second gear transmission set is connected between the motor and a second end of the second transmission shaft.

9. The sexual stimulation device according to claim 2, wherein the driving assembly comprises motor and a transmission unit connected between the motor and the first massage element, the transmission unit is configured to drive the first massage element to slide relative to the casing.

10. The sexual stimulation device according to claim 9, wherein the transmission unit comprises a gear transmission set connected to the motor, at least one guide rail, and a support slidably mounted on the at least one guide rail, the first massage element is mounted on the support, the support has a groove extending in a direction intersecting the at least one guide rail, the gear transmission set comprises a protrusion slidably arranged in the groove.

11. (canceled)

12. The sexual stimulation device according to claim 2, wherein the driving assembly comprises a motor and a transmission unit connected between the motor and the first massage element, the transmission unit is configured to drive the first massage element to rotate relative to the casing.

13. The sexual stimulation device according to claim 12, wherein the transmission unit comprises an output gear in torque transmission connection with the motor and a ferrule having a gear portion, the ferrule is fixedly mounted around the first massage element, the gear portion meshes with the output gear.

14. The sexual stimulation device according to claim 2, wherein the driving assembly comprises a motor and a transmission unit connected between the motor and the second massage element, the transmission unit is configured to drive the second massage element to swing and/or rotate relative to the casing.

15. The sexual stimulation device according to claim 14, wherein the transmission unit drives the second massage element to reciprocally swing and/or rotate towards or away from a central longitudinal axis of the massage space.

16. (canceled)

17. The sexual stimulation device according to claim 14, the driving assembly comprises a gearbox connected between the motor and the transmission unit.

18. The sexual stimulation device according to claim 14, wherein the transmission unit comprises a wheel in torque transmission connection with the motor, a shaft rod, and a support member, the shaft rod is eccentrically mounted on the wheel relative to its rotation axis, the support member is at least partially engaged in the second massage element and provided with a connection end movably engaged with the shaft rod.

19-21. (canceled)

22. The sexual stimulation device according to claim 14, wherein the transmission unit comprises a curved shaft and a gear transmission set, the curved shaft is at least partially engaged in the second massage element, the gear transmission set is configured to drive the curved shaft to rotate along a rotation axis relative to the casing, a portion of the curved shaft is inclined relative to the rotation axis.

23. The sexual stimulation device according to claim 22, wherein the gear transmission set comprises a worm, a worm gear, a first driving gear, and a second driving gear, the worm is in torque transmission connection between the motor and the worm gear, the first driving gear, which is meshed between the worm gear and the second driving gear, comprises a protrusion for driving the first massage element to slide, the second driving gear is in torque transmission connection with the curved shaft.

24. The sexual stimulation device according to claim 2, wherein the first massage element is at least partially arranged outside the casing.

25. (canceled)

26. The sexual stimulation device according to claim 1, wherein the second massage component is provided with a stimulating component received in the second massage element, the stimulating component comprises at least one selected from a group consisting of a vibration motor, electric heater, a temperature control sensor, a haptic sensor, and a light emitter.

27. The sexual stimulation device according to claim 1, wherein at least one of the first massage element and the second massage element is made of a soft material selected from a group comprising: silicone, TPE, TPU, PVC and any combination thereof, and the soft material has a Shore A hardness not exceeding 30.

28. The sexual stimulation device according to claim 1, further comprising a negative pressure generator arranged within the first massage component and configured to change air pressure inside the first massage component.

29. (canceled)

30. The sexual stimulation device according to claim 1, further comprising at least one handle disposed on the first massage component.

31. A sexual stimulation device, comprising:
a first massage component, defining an elongated massage space for accommodating a penis, the massage space having a first axial end for insertion of the penis and a second axial end opposite to the first axial end, at least the first axial end being open;
a second massage component, connected to the first massage component and arranged at or adjacent to a periphery of the first axial end of the massage space;
a driving assembly, comprising a motor and a gearbox, wherein the motor is configured to output torque to the second massage component via the gearbox and drive the second massage component to move.

32. The sexual stimulation device according to claim 31, wherein the second massage component comprises a second massage element, the driving assembly comprises a transmission unit connected between the gearbox and the second massage element, the transmission unit is configured to drive the second massage element to swing and/or rotate.

33. The sexual stimulation device according to claim 32, wherein the second massage element has an swing range of 5° to 120° about a swing axis.

34. The sexual stimulation device according to claim 32, wherein a distance between the second massage element and a longitudinal axis of the massage space is in a range of 0 to 200 mm.

35. The sexual stimulation device according to claim 32, wherein the second massage component is provided with a stimulating component received in the second massage element, the stimulating component comprises at least one selected from a group consisting of a vibration motor, electric heater, a temperature control sensor, a haptic sensor, and a light emitter.

36. The sexual stimulation device according to claim 31, wherein a transmission ratio of the gearbox is in a range of 5:1 to 100:1.

37. A sexual stimulation device, comprising:
a first massage component, defining an elongated massage space for accommodating a penis, the massage space having a first axial end for insertion of the penis and a second axial end opposite to the first axial end, at least the first axial end being open;
a second massage component, connected to the first massage component and comprising a second massage element, the second massage element being arranged at or adjacent to a periphery of the first axial end of the massage space;
wherein the second massage element has a recess on a surface facing a longitudinal extension of an outer periphery of the elongated massage space.
